(19) United States
(12) Patent Application Publication
(10) Pub. No.: US 2007/0028025 A1
(43) Pub. Date: Feb. 1, 2007

(54) Connection structure of portable information apparatus for connecting extensive device

(76) Inventors: Yu Chen, Taipei City (TW); Yun Ping Liu, Taipei City (TW); Hung Chang Liao, Sinjhuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/239,025

(22) Filed: Sep. 30, 2005

(30) Foreign Application Priority Data
Jul. 26, 2005 (TW) 094212668

(51) Int. Cl. G06F 13/36

(52) U.S. Cl. 710/315

(57) ABSTRACT

A connection structure of a portable information apparatus is described in the present invention. The connection structure includes a connector and a switch module. The connector has a first interface and a second interface. Therein, the connector is used to connect with a display processing device via the first interface or connect with an extensive device via the second interface. When the connector connects to the display processing device, the switch module switches signals provided by the display processing device and a built-in display processing device of the portable information apparatus. In this way, the portable information apparatus can selectively use the display processing device and the extensive device via a connector.

### BACKGROUND OF THE INVENTION

1. Field of the Invention

The present invention is related to a connection structure of a portable information apparatus for connecting an extensive device, and more particularly, to a portable information apparatus's connection structure that has a connector and a switch for selectively using a display processing device or an extensive device.

2. Description of Related Art

With the progress of information technologies, portable information apparatuses are extensively used nowadays. Since portable information apparatuses have high mobility, they can be used to send e-mail, compose reports, and process data at any time and any place. Hence, they are convenient efficient for daily works.

Although portable information apparatuses are very useful for people, their rooms for accommodating extensive devices is much smaller than common desk-top computers because portable information apparatuses must be compact. In general, portable information apparatuses are made only able to be equipped with basic equipment. Once they need to connect to additional extensive devices, they are restricted because of limited rooms.

Reference is made to FIG. 1, which shows a conventional portable computer capable of selectively connecting to a floppy disk drive or a hard disk disclosed in Taiwan Patent No. 241911. The portable computer 1′ has a slot 10′ inside. The slot 10′ has a floppy disk drive connector 12′ and a hard disk connector 14′ disposed therein. Hence, the portable computer 1′ can connect to a floppy disk drive or a hard disk 16′ via the slot 10′.

Although the above-mentioned conventional connection structure of the portable computer 1′ can selectively connect to two kinds of extensive storage devices, it cannot connect to an extensive display processing device. When one wants to execute a 3-D drawing program, a 3-D image processing program or a video game program, he can only use the built-in display processing device of the portable computer 1′ to display low-quality images. The connectional connection structure doesn't has a switch module for switching signals provided by a high-quality display processing device and the built-in display processing device of the portable computer 1′. It is inconvenient for users.

Accordingly, as discussed above, the prior art still has some drawbacks that could be improved. The present invention aims to resolve the drawbacks in the prior art.

### SUMMARY OF THE INVENTION

An objective of the present invention is to provide a connection structure of a portable information apparatus for connecting an extensive device. The connection structure has a connector and a switch module. The connector is used for the portable information apparatus to connect selectively to a display processing device or an extensive device. When the connector connects to the display processing device, the portable information apparatus can switch between a built-in display processing device and the display processing device connected to the connector. Thereby, the functionality of the portable information apparatus is improved.

For achieving the objectives above, the present invention provides a connection structure of a portable information apparatus. The portable information apparatus is connected electrically to the connection structure. Therein, the connector includes a first interface and a second interface. One can use the connector to connect with a display processing device via the first interface or connect with an extensive device via the second interface. In this way, without increase of thickness or weight of the portable information apparatus, the portable information apparatus can selectively use two extensive devices with different interfaces via the same extensive slot. Thus, the functionality of the portable information apparatus is improved.

In addition, the connection structure of the portable information apparatus further has a switch module. When the connector connects to a high-quality display processing device, the switch module is switched to the high-quality display processing device to output the signal provided therefrom. In this way, one can use the high-quality display processing device to execute a program that needs high display quality. Thus, the functionality of the portable information apparatus is further improved.

The above summaries are intended to illustrate exemplary embodiments of the invention, which will be best understood in conjunction with the detailed description to follow, and are not intended to limit the scope of the appended claims.

### BRIEF DESCRIPTION OF THE DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings, in which:

FIG. 1 shows a conventional portable computer capable of selectively connecting to a floppy disk drive or a hard disk;

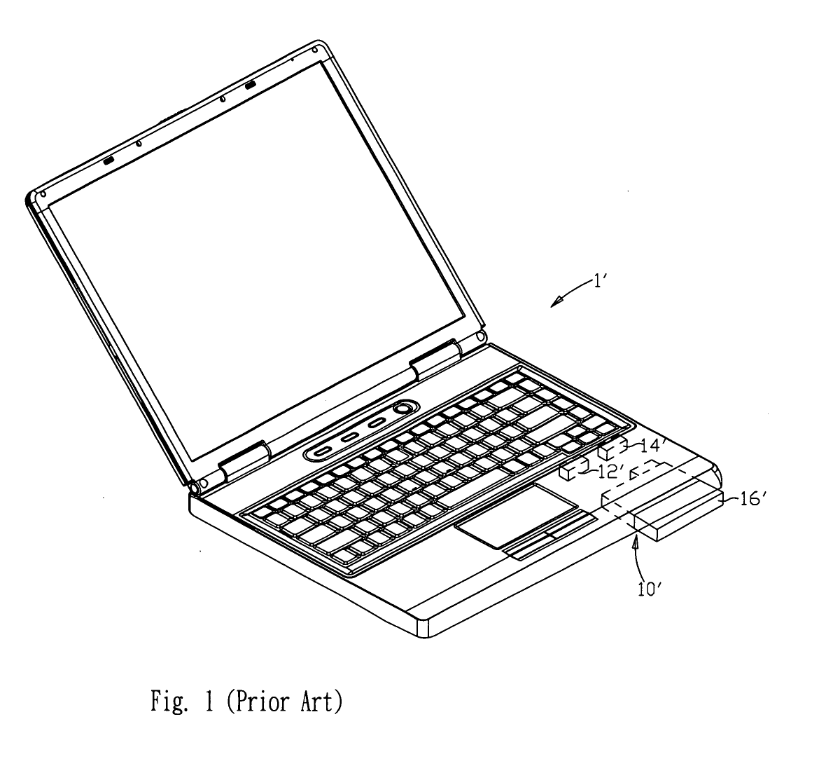

FIG. 2 shows a schematic diagram of a preferred embodiment a portable information apparatus in accordance with the present invention;

FIG. 3 shows a schematic diagram of a portable information apparatus connecting to a device with a PCI-Express interface in accordance with the present invention;

FIG. 4 shows a schematic diagram of a portable information apparatus connecting to a device with an IDE interface in accordance with the present invention; and

FIG. 5 is a block diagram of a preferred embodiment in accordance with the present invention.

### DETAILED DESCRIPTION OF PREFERRED EMBODIMENTS

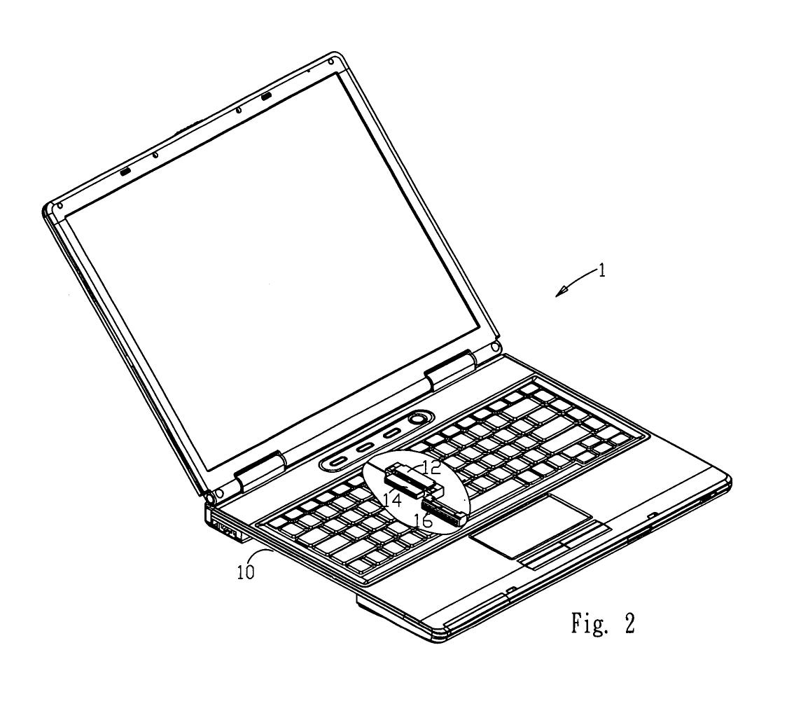

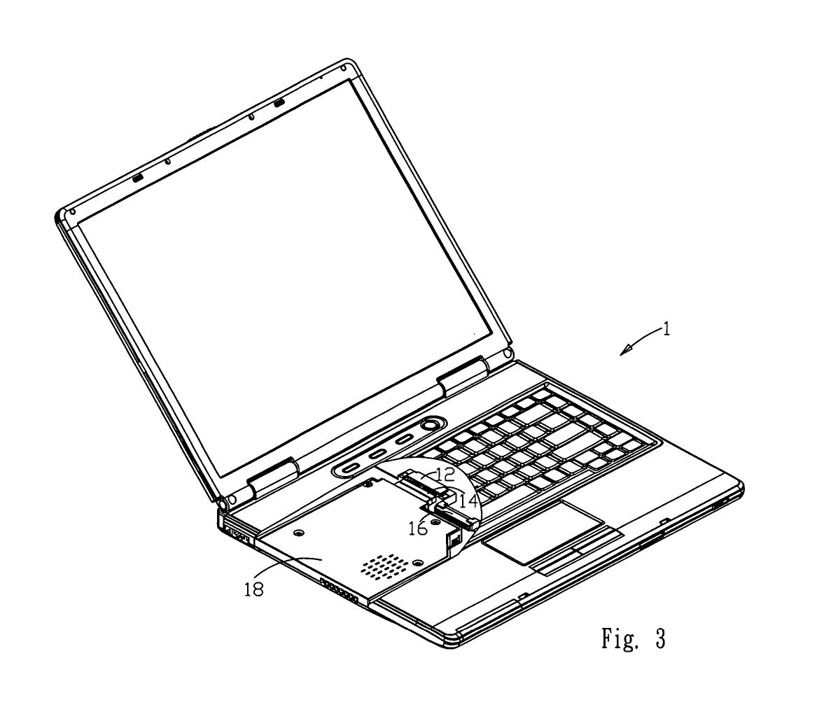

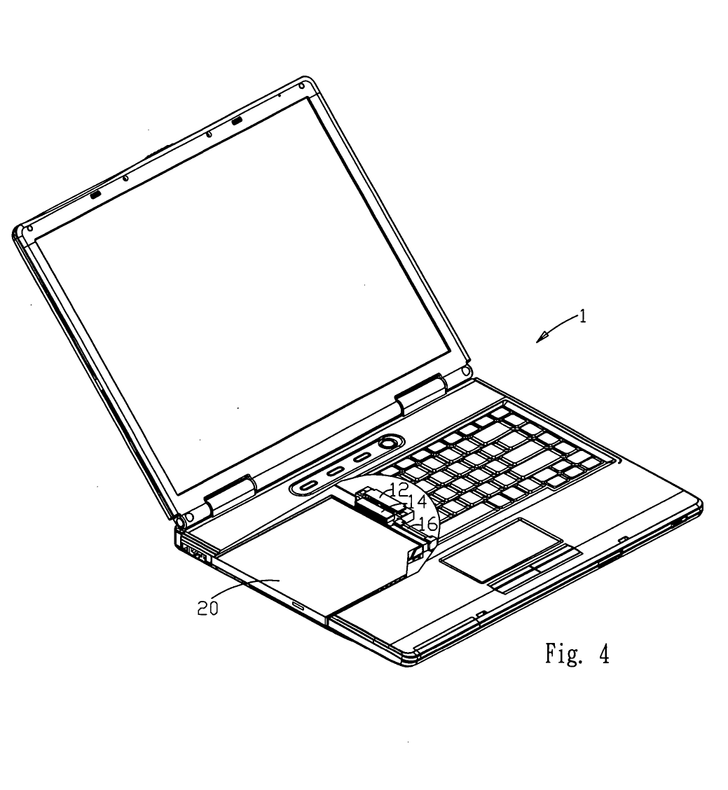

Reference is made to FIGS. 2-4, which respectively show schematic diagrams of a preferred embodiment of a portable information apparatus having no extensive devices, connecting to a device with a PCI-Express interface, and connecting to a device with an IDE interface in accordance with the present invention. As shown in the figures, the portable information apparatus 1 is a notebook computer. The portable information apparatus 1 has a slot 10. The slot 10 has a connector 12 disposed therein. The connector 12 is connected electrically to the portable information apparatus 1 and includes a first interface 14 and a second interface 16. The first interface 14 and the second interface 16 are used to connect to a display processing device 18 and an extensive device 20 respectively. The display processing device 18 and the extensive device 20 can be inserted into the slot 10. In this way, the portable information apparatus 1 can be selectively equipped with the display processing device 18 or the extensive device 20.

The first interface 14 mentioned above fits in with the PCI-Express, PCI or AGP interface standard for connection with a display processing device with a PCI-Express, PCI, or AGP interface. The second interface 16 fits in with the IDE interface standard for connection with a optical access device with an IDE interface.

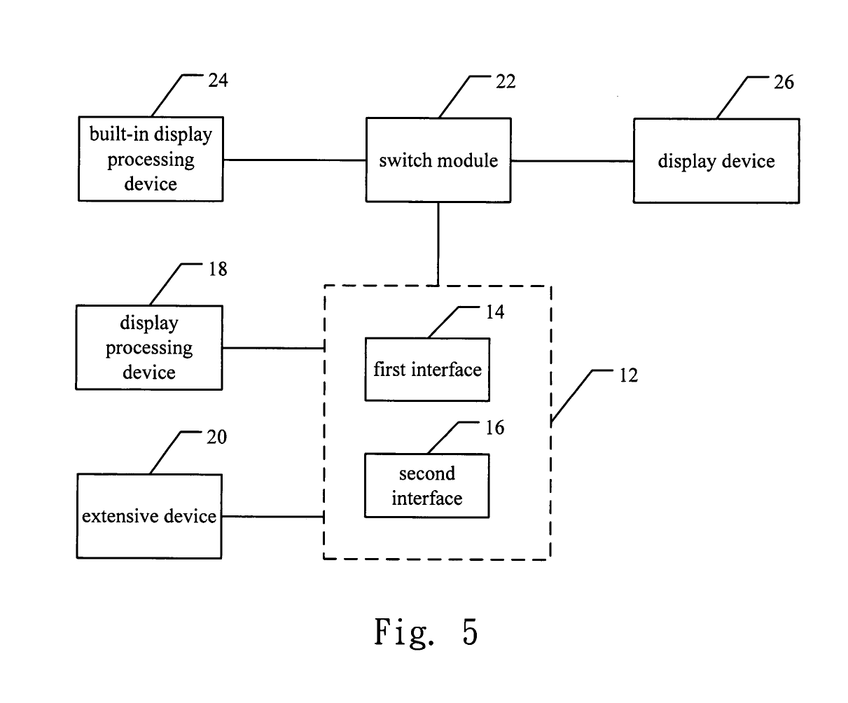

In addition, reference is made to FIG. 5, which is a block diagram of a preferred embodiment in accordance with the present invention. As show in FIG. 5, the portable information apparatus 1 has the connector 12 and a switch module 22. Therein, the connector includes the first interface 14 and the second interface 16. In this embodiment of the present invention, the first interface 14 is used to connect with the display processing device 18. The display processing device 18 is a high-quality display processing device. For example, the display processing device 18 can be an accelerated graphic port interface or a peripheral component interconnect interface. The switch module 22 can be an electronic switch and connects to a built-in display processing device 24 of the portable information apparatus and the connector 12. The built-in display processing device 24 is a low-quality display processing device. The switch module 22 is used to switch signals provided by the display processing device 18 and the built-in display processing device 24.

Therein, both of the extensive device 20 and the display processing device 18 can be modulized individually to fit in with the size of the slot 10. It is convenient for attachment or detachment of the devices.

Furthermore, the switch module 22 is connected electrically to a display device 26 and outputs the signal provided by the display processing devices thereto. One can use the switch module 22 and the connector 12 to connect and use extensive display processing devices with various display qualities freely.

To sum up, the present invention is related to a connection structure of a portable information apparatus for connecting an extensive device. By using the first interface and the second interface of the connector of the present invention, the portable information apparatus can connect with a display processing device or an extensive device. Using the connector, the portable information apparatus can selectively use two extensive devices that have different interfaces. In addition, when the connector connects to an extensive display processing device, the portable information apparatus can use a switch module to select the signals provided by the extensive display processing device for image display. Hence, the present invention possesses capability of connecting an extensive display processing device.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A connection structure of a portable information apparatus, comprising:
a connector connecting to the portable information apparatus and including a first interface and a second interface;
wherein the connector is used to connect with a first extensive device via the first interface or connect with a second extensive device via the second interface.

2. The connection structure as claimed in claim 1, wherein the portable information apparatus further has a slot and the connector is disposed inside the slot.

3. The connection structure as claimed in claim 1, wherein the first interface fits in with a PCI-Express interface standard, a PCI interface standard, or a AGP interface standard.

4. The connection structure as claimed in claim 1, wherein the second interface fits in with an IDE interface standard or an ISA interface standard.

5. The connection structure as claimed in claim 1, wherein the first extensive device is a display processing device.

6. The connection structure as claimed in claim 5, further comprising:
a switch module used to connect electrically to the display processing device for switching signals provided by the display processing device and a built-in display processing device.

7. The connection structure as claimed in claim 6, wherein the switch module is an electronic switch.

8. The connection structure as claimed in claim 1, wherein the first extensive device is a device with a PCI-Express interface.

9. The connection structure as claimed in claim 1, wherein the second extensive device is an optical access device.

10. The connection structure as claimed in claim 1, wherein the portable information apparatus is a notebook computer.

11. A connection structure of a portable information apparatus, the portable information apparatus having a first display processing device connected thereto, the connection structure comprising:
a connector connecting to the portable information apparatus and including a first interface and a second interface, wherein the connector is used to connect with a second display processing device via the first interface or connect with an extensive device via the second interface; and
a switch module used to connect electrically to the connector, wherein the switch module switches signals provided by the first display processing device and the second display processing device when the connector connects to the second display processing device.

12. The connection structure as claimed in claim 11, wherein the portable information apparatus further has a slot and the connector is disposed inside the slot.

13. The connection structure as claimed in claim 11, wherein the first interface fits in with a PCI-Express interface standard, a PCI interface standard, or a AGP interface standard.

14. The connection structure as claimed in claim 11, wherein the second interface fits in with an IDE interface standard.

15. The connection structure as claimed in claim 11, wherein the switch module is an electronic switch.

16. The connection structure as claimed in claim 11, wherein the extensive device is an optical access device.

17. The connection structure as claimed in claim 11, wherein the portable information apparatus is a notebook computer.
